(19) United States
(12) Patent Application Publication
(10) Pub. No.: US 2009/0101501 A1
(43) Pub. Date: Apr. 23, 2009

(54) ROOM TEMPERATURE GAS SENSORS

(76) Inventors: Xiao-ming Tao, Hong Kong (CN); An Yang, Hong Kong (CN); Rong-xin Wang, Hong Kong (CN); Shun Cheng Lee, Hong Kong (CN); Charles Surya, Hong Kong (CN)

Correspondence Address: EVAN LAW GROUP LLC, 600 WEST JACKSON BLVD., SUITE 625, CHICAGO, IL, 60661, US

(21) Appl. No.: 11/873,796

(22) Filed: Oct. 17, 2007

(51) Int. Cl. G01N 27/26; H01S 4/00

(52) U.S. Cl. 204/424; 29/592.1

(57) ABSTRACT

A gas sensor may include a mat including nanofibers attached to a substrate layer, a first electrode in electrical communication with one end of the mat, and a second electrode in electrical communication with the other end of the mat. The sensitivity of the gas sensor for carbon monoxide at a concentration of 50 ppm in air, and at a temperature from about 20° C. to 26° C., is at least 1.29.

### BACKGROUND

Due to their large surface-to-volume ratio and small grain size, nano-structured materials have been demonstrated to be excellent candidates for ultra-sensitive and highly miniaturized sensors. They are most suitable for intelligent textiles, which normally have strict requirements on sensor size and weight, operating temperature, power consumption, and flexibility.

Tin oxide has a large band gap and highly achievable carrier concentration, which make it suitable for gas sensors. However, most tin oxide gas sensors are effective only at temperatures above 200° C.

One-dimensional (1D) and quasi-1D semi-conducting metal oxide nanostructures, such as nanowires and nanobelts, have the smallest dimension for effective electron transport and, therefore, may be ideal candidates for sensitive and efficient sensors that translate gas recognition into an electrical signal. In order to work at room temperature, p-type tellurium oxide nanowires have been investigated for sensing ammonia and nitrogen dioxide. The complexity and cost of fabrication of these nanowires, as well as their power consumption, may hinder their applications.

Consequently, it is desirable to develop a gas sensor that is operable at room temperature, with low cost and low power consumption.

### SUMMARY

According to one aspect, a gas sensor may include a mat including nanofibers attached to a substrate layer, a first electrode in electrical communication with one end of the mat, and a second electrode in electrical communication with the other end of the mat. The sensitivity of the gas sensor for carbon monoxide at a concentration of 50 ppm in air, and at a temperature from about 20° C. to 26° C., is at least 1.29.

According to another aspect, a method of making a gas sensor may include attaching a mat including nanofibers to a substrate layer, connecting a first electrode in electrical communication with one end of the mat, and connecting a second electrode in electrical communication with the other end of the mat.

According to yet another aspect, a gas sensor may include a mat including nanofibers attached to a substrate layer, a first electrode in electrical communication with one end of the mat, and a second electrode in electrical communication with the other end of the mat. The nanofibers may include semiconductor metallic oxide nanofibers and multi-walled carbon nanotubes.

### BRIEF DESCRIPTION OF THE DRAWINGS

FIG. 1 depicts a perspective view of an embodiment of a gas sensor.

FIG. 2A depicts field emission scanning electron microscopy (FESEM) images of SnO₂ nanofibers calcinated at 500° C.

FIG. 2B depicts FESEM images of SnO₂-multi-walled carbon nanotube (MWCNT) nanofibers calcinated at 500° C.

FIG. 3A depicts a low-magnification transmission electron microscopy (TEM) image of SnO₂ nanofibers calcinated at 500° C.

FIG. 3B depicts a high resolution TEM image of SnO₂ nanofibers calcinated at 500° C.

FIG. 3C depicts an in-plane bright field TEM micrograph of SnO₂-MWCNT composite nanofibers.

FIG. 3D depicts an in-plane dark field TEM micrograph of SnO₂-MWCNT composite nanofibers.

FIG. 3E depicts a high resolution TEM image of MWCNT wall.

FIG. 3F depicts an in-plane bright field TEM micrograph of SnO₂-MWCNT composite nanofibers.

FIG. 4 depicts Raman spectra of (a) SnO₂-MWCNT nanofibers calcinated at 500° C. and (b) SnO₂ nanofibers calcinated at 500° C.

FIG. 5A depicts I-V curves of a pure SnO₂ fibers sensor measured in air and at 500 ppm CO.

FIG. 5B depicts I-V curves of a SnO₂-MWCNT nanofibers sensor measured in air and with various concentrations of CO.

FIG. 5C depicts the sensitivity of a SnO₂-MWCNT fiber sensor vs CO concentration with 3V of applied voltage.

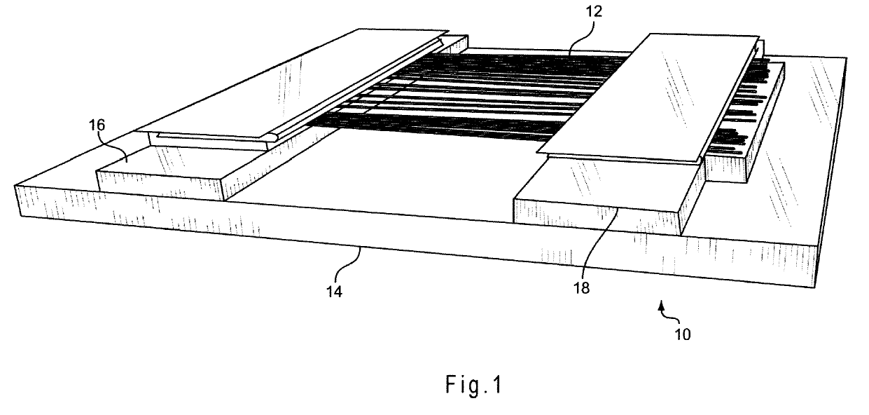

### DETAILED DESCRIPTION

Reference will now be made in detail to a particular embodiment of the invention, examples of which are also provided in the following description. Exemplary embodiments of the invention are described in detail, although it will be apparent to those skilled in the relevant art that some features that are not particularly important to an understanding of the invention may not be shown for the sake of clarity.

Furthermore, it should be understood that the invention is not limited to the precise embodiments described below and that various changes and modifications thereof may be effected by one skilled in the art without departing from the spirit or scope of the invention. For example, elements and/or features of different illustrative embodiments may be combined with each other and/or substituted for each other within the scope of this disclosure and appended claims. In addition, improvements and modifications which may become apparent to persons of ordinary skill in the art after reading this disclosure, the drawings, and the appended claims are deemed within the spirit and scope of the present invention.

A gas sensor 10 may include fiber mats 12 attached to a substrate layer 14, a first electrode 16 in electrical communication with one end of the fiber mats 12, and a second electrode 18 in electrical communication with another end of the fiber mats 12. Metal conductive paint may be used to cover the fiber mats 12, and may be configured to measure any change in surface resistance during exposure to carbon monoxide. Adhesive tapes may be fixed adjacent to one of the electrodes 16 or 18 to allow the fiber mats 12 to directly contact the electrodes 16 and 18.

The fiber mats 12 may include nanofibers of a semiconductor metallic oxide and of a metallic oxide/multi-walled carbon nanotubes (MWCNTs) composite. Examples of the semiconductor metallic oxide may include tin oxide, gallium oxide, and mixtures thereof. Examples of MWCNTs may include composite nanofibers such as tin oxide/carbon nanotubes, gallium oxide/carbon nanotubes, indium oxide/carbon nanotubes and mixtures thereof. The substrate layer 14 may be made of a polymer, such as polyethylene terephthalate (PET), polymethyl methacrylate (PMMA), polyvinyl chloride (PVC) and mixtures thereof, or it may be made of a ceramic, such as aluminum oxide (Al₂O₃) and silicon dioxide (SiO₂). The electrode 16 and 18 may be made of aluminum, gold, copper and combinations thereof.

Fiber mats 12 may be prepared using electrospinning, although other known methods in the art such as thermal deposition, solution-based crystal growth, laser ablation, and template-based approaches may also be used. For example, Sb-doped SnO₂ nanofibers may be prepared by electrospinning a solution containing poly(vinyl pyrrolidone) (binder), tin and antimony (III) alkoxides, acetic acid and organic solvents. Other examples of applicable polymers may include polyolefin, polyacetal, polyamide such as nylon, polyester, cellulose ether and ester, polyalkylene sulfide, polyarylene oxide, polysulfone, modified polysulfone polymers, polystyrene, polyacrylonitrile, polycarbonate, and mixtures thereof.

A precursor solution containing dimethyldineodecanoate tin, poly(ethylene oxide)/water, and chloroform may be used to electrospin SnO₂ microfibers. MWCNTs may be dispersed into tin oxide precursor solutions to obtain SnO₂/MWCNT composite nanofibers through an electrospinning process, to form fiber mats 12.

While not being bounded by theory, it is believed that when pure tin oxide is placed in carbon monoxide at room temperature, few active chemisorbed oxygen ions react with CO, so that no change of resistance would be observed. After being pretreated in concentrated CTAB (Cetyltrimethylammonium bromide) under sonication and calcinations in air, abundant active sites may be created on the surface of MWCNT walls, which have strong binding energies to CO. As a result, the functionalized MWCNT would have a strong tendency to absorb CO and H₂O molecules, and would experience a drastic change in electrical properties when exposed to carbon monoxide. Such a change in resistance can be measured and related to the quantity of CO.

The resistance of SnO₂-MWCNT sensors decreases upon exposure to reducing gas molecules, suggesting that the functionalized MWCNTs (F-MWCNTs) have a n-type semiconductor behavior. A proposed interaction mechanism of CO molecules with F-MWCNTs can be described as:

F-MWCNTs+CO_{(g)}→F-MWCNTs-CO_{(ad)},

F-MWCNTs+H₂O_{(g)}→F-MWCNTs-OH_{(ad)}+H⁺+e⁻,

F-MWCNTs-CO_{(ad)}+F-MWCNTs-OH→CO_{2(g)}+2F-MWCNTs+H⁺+e⁻.

Therefore, the concentration of the conduction band electrons increases, and the conductance increases. On the other hand, the ion O⁻ is easily adsorbed on MWCNT surface in air, that is

O_{2(g)}+2e⁻(F-MWCNTs)→2O⁻_{(ad)}

If CO gas is introduced into the gas chamber, it may cause the desorption of O₂ by the following way:

CO_{(g)}+O⁻_{(ad)}→CO_{2(g)}+e⁻

This process also may contribute to an improvement in the sensitivity. That is, an oxygen ion that has been adhered on the MWCNT surface may be desorbed by being reacted with a reactive gas. The electron which had been captured by the oxygen ion may be converted to a free electron, resulting in an increase in the conductivity of the gas. The conductivity may be measured, and the existence of CO gas may be determined.

The gas sensor 10 may quantitatively detect carbon monoxide at room temperature of from about 20° C. to 26° C. For example, the gas sensor 10 may detect air mixed with a given concentration of CO gas flowed at 3000 ml/min through the gas chamber at 23.5° C. and ambient pressure. The gas sensor 10 may have a high sensitivity. For example, the mean sensitivity is 1.29 for 50 ppm CO at 23.5° C. Sensitivity (S) is defined as S=Rₐ/R_{g}, where Rₐ is the electrical resistance of the fiber mats in atmospheric air (˜22% relative humidity), and R_{g} is the resistance of the fiber mats in a CO-air mixture at the indicated concentration and temperature.

The gas sensor 10 may be used in textiles and clothing. For example, the gas sensor may be connected to transducers and circuit components for sensing external environmental conditions, and the sensor, transducers and/or circuit components may be integrated into textiles or clothing. The textile or clothing may be used, for example, to detect toxic gases. The gas sensor 10 may be manufactured commercially at relatively low cost and may be of reduced size relative to gas sensing devices currently available. Moreover, the fiber mats 12 may be fabricated into flexible substrates, and thus the gas sensor 10 may possess less weight and have good portability.

The gas sensor 10 may be used to detect carbon monoxide present in environments such as fuel cells, laboratories, mines and industrial smoke stacks.

Furthermore, it should be understood that the gas sensor is not limited to the precise embodiments described below and that various changes and modifications thereof may be effected by one skilled in the art without departing from the spirit or scope of the invention. For example, elements and/or features of different illustrative embodiments may be combined with each other and/or substituted for each other within the scope of this disclosure and appended claims.

The gas sensor is further illustrated by the following examples, which are not to be construed in any way as imposing limitations upon the scope thereof. On the contrary, it is to be clearly understood that resort may be had thereof which, after reading the description herein, may suggest themselves to those skilled in the art without departing from the spirit of the specification and/or the scope of the appended claims.

### EXAMPLES

### Example 1

### Method and Conditions of Preparing a Pure SnO₂ Precursor Solution

To prepare a pure SnO₂ precursor solution, 2.4 g of poly(vinyl alcohol) (PVA; molecular weight M=88×103 g/mol, available from J&K Chemical, Ltd.) was added to 16 g of de-ionized water. The mixture was stirred for 6 hrs in a water bath at 70° C. until PVA was completely dissolved. Then, the solution was combined with 10 g of anhydrous tin (IV) chloride (SnCl₄) followed by magnetic stirring for 6 hrs.

### Example 2

### Method and Conditions of Preparing a SnO₂-MWCNT Precursor Solution

To prepare a SnO₂-MWCNT precursor solution, 120 mg of Cetyltrimethylammonium bromide (CTAB, available from Dupont) was dissolved in 16 g of de-ionized water. 40 mg of MWCNTs (available from NTP, Shenzhen, China) was dispersed in the CTAB aqueous solution under sonication for 15 min (800 W, JY92, Ninbo Biotech, Ltd.). 2.3 g of PVA was added to the MWCNT dispersion and stirred for 6 hrs in a water bath at 70° C. This solution was then combined with 10 g of SnCl₄, followed by magnetic stirring for 6 hrs.

### Example 3

### Method and Conditions of Electrospinning SnO₂-Containing Nanofibers

To prepare SnO₂-MWCNT composite nanofibers, the precursor solutions from Example 1 and Example 2 were loaded into a 20 ml plastic syringe equipped with a 23 gauge, 1.5 in. long stainless steel needle. The needle was connected to a nanofiber electrospinning unit (NEU-010, Kes Kato Tec Co.), which can generate DC voltage up to 40 kV.

For the pure SnO₂ nanofibers, the applied voltage was 26 kV, and the distance between the needle tip and the collector was 15 cm. The target drum speed and syringe pump speed were set, respectively, to 2 m/min and 0.04 mm/min for the precursor solution.

For the SnO₂-MWCNT nanofibers, the applied voltage was 23 kV, and the distance between the needle tip and the collector was 15 cm. The target drum speed and syringe pump speed were set, respectively, to 2 m/min and 0.03 mm/min for the precursor solution.

The as-prepared fiber mats were collected and calcinated (CWF 1200, Carbolite Co.) at 500° C. in air to obtain SnO₂ and SnO₂-MWCNT nanofibers.

### Example 4

### Characteristics of Electrospun SnO₂-MWCNT Composite Nanofibers

The nanofibers of Example 3 were characterized by field emission scanning electron microscopy (FESEM; JEOL JSM-6335F), x-ray diffraction (XRD; Philips PW3710, Cu Kα radiation, and transmission electron microscopy (TEM; JEOL JEM-2010F).

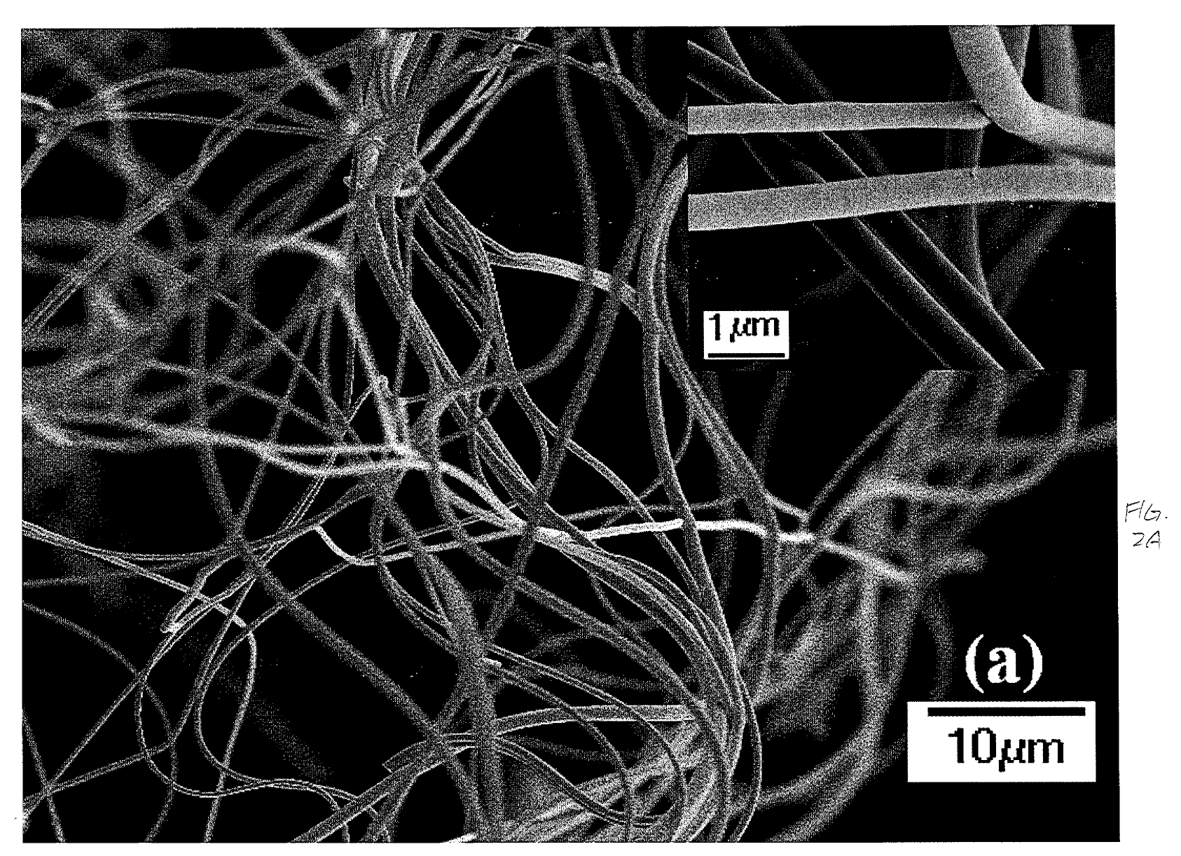

The FESEM micrographs in FIG. 2A and FIG. 2B depict that the electrospun SnO₂ nanofibers (2A) and the SnO₂-MWCNT composite nanofibers (2B) were randomly oriented on the substrate, and that the diameters of the fibers were between 300 and 800 nm. The curved nanofibers had a typical length of several tens of millimeters.

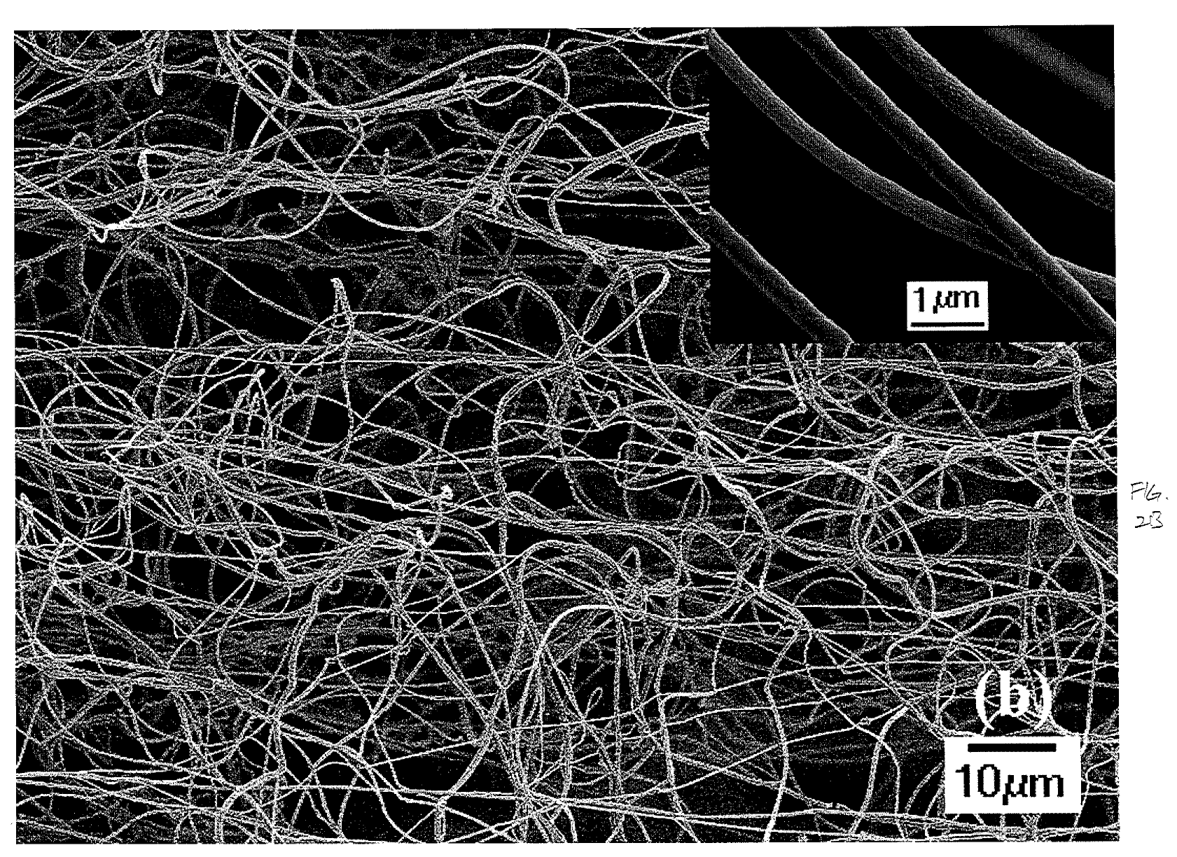

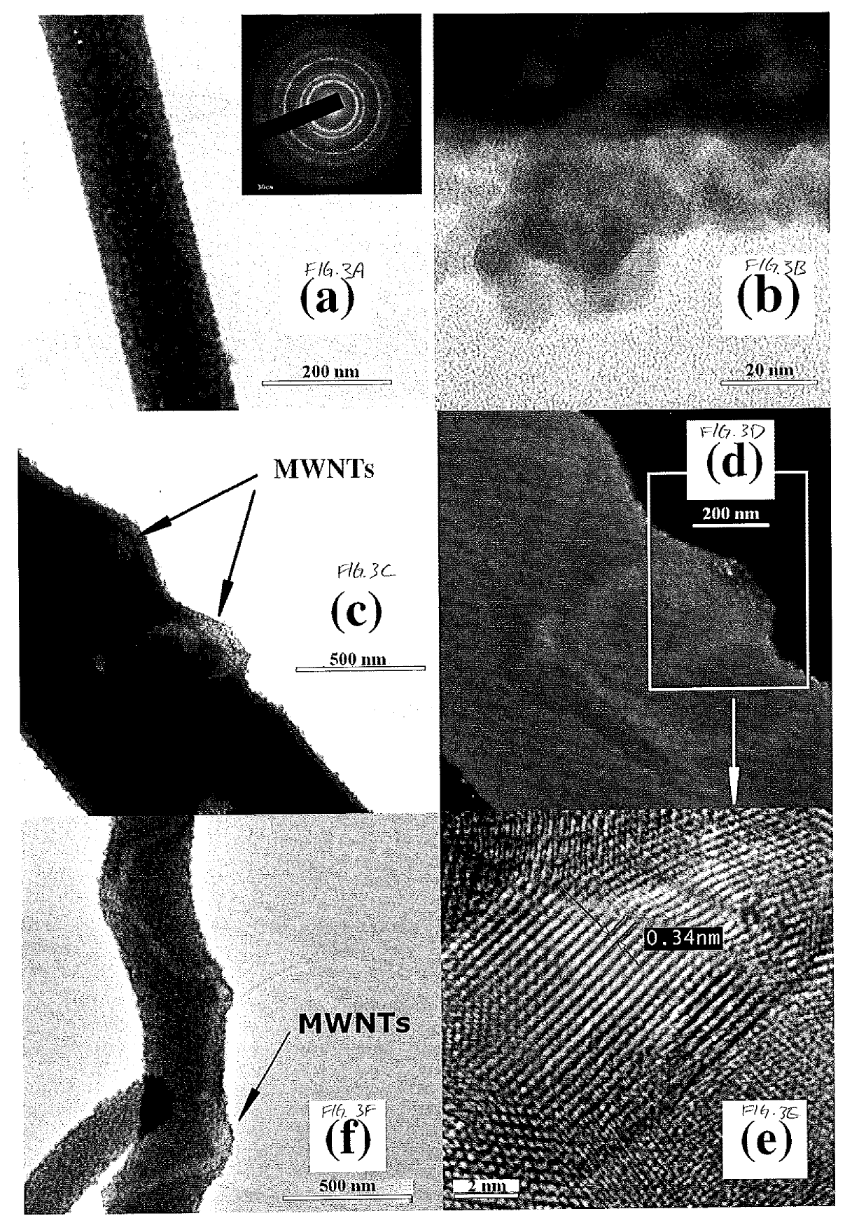

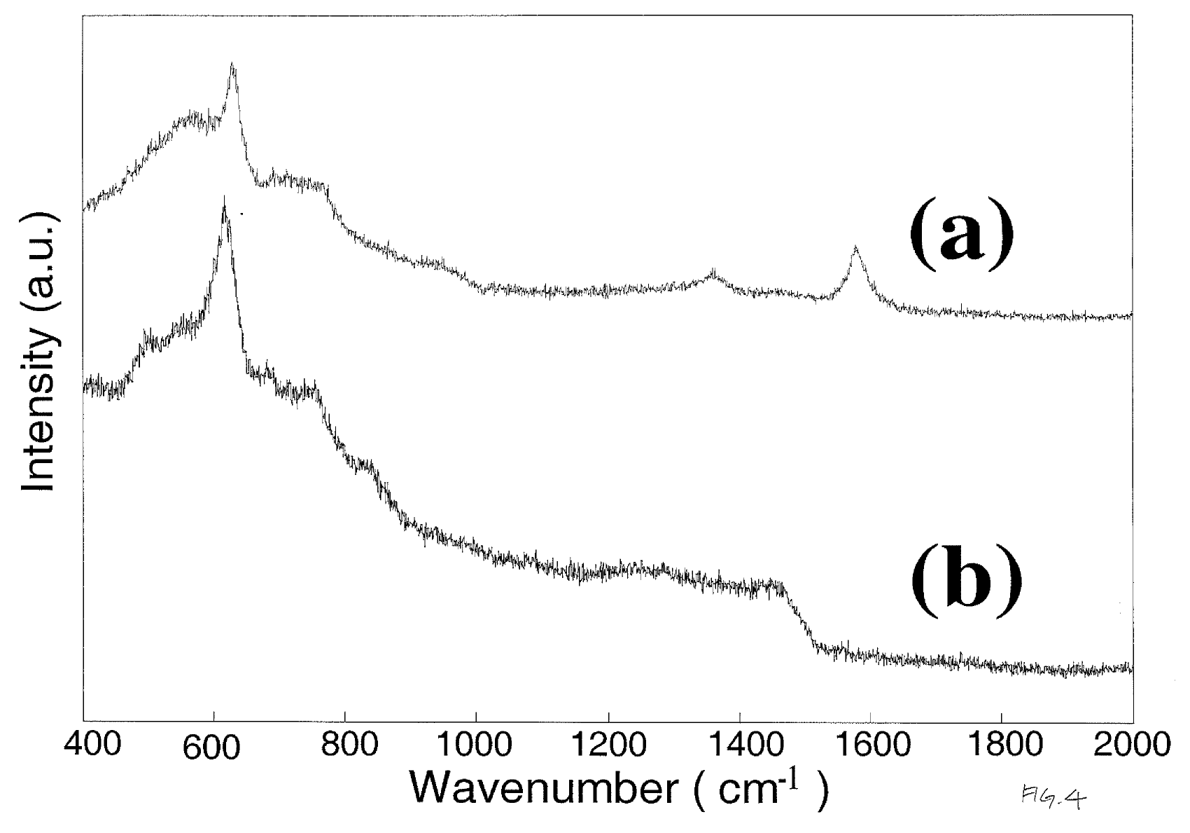

FIG. 3A depicts a low-magnification TEM image of pure SnO₂ nanofibers. The corresponding ringlike electron diffraction pattern indicates that the nanofibers were polycrystalline. The high resolution TEM micrograph as depicted in FIG. 3B revealed that samples calcinated at 500° C. consisted of randomly orientated nanocrystallites of SnO₂ with diameters of approximately 15 nm.

The in-plane bright field TEM micrograph of SnO₂-MWCNT composite nanofibers and its corresponding dark field image are depicted in FIGS. 3C and 3D, respectively. One nanotube was found to orient along the fiber axis, while another exhibited some degree of tortuosity.

FIG. 3E depicts a HRTEM image of the MWCNT wall, showing the 0.34 nm separations between adjacent graphene sheets. This spacing coincided with the plane spacing of multiwall carbon nanotubes. The XRD patterns of the nanofiber samples calcinated at 500° C. show that the SnO₂-MWCNT composite nanofibers had diffractive peaks associated with rutile SnO₂. FIG. 3F depicts an in-plane bright field TEM micrograph of SnO₂-MWCNT composite nanofibers.

FIG. 4A depicts the Raman spectrum of SnO₂-MWCNT composite nanofibers. The D and G modes of doped MWCNTs appeared near 1362 and 1578 cm⁻¹, respectively. For the pure SnO₂ fibers, as depicted in FIG. 4B, the fundamental Raman active mode A_{1g}, which usually appears in polycrystalline SnO₂ materials, is observed at 617 cm⁻¹. The little A_{1g} peak shifts can be found by comparing the data from the pure SnO₂-nanofibers with those composite nanofibers.

### Example 5

### A Gas Sensor Based on the Nanofiber Mats

A polyester substrate [polyethylene terephthalate (PET), available from DuPont, 9×6×0.175 mm] with aluminum (Al) electrodes was used. The PET substrates were cleaned by sequential treatment with nonionic detergent, de-ionized water, acetone, and isopropyl alcohol. Each treatment included immersing the substrate in an ultrasonic bath for 10 min. The substrate was then dried in a vacuum oven for 12 hours at 60° C.

Two Al electrodes were mounted on a substrate. The electrodes had a linewidth of 1 mm, and were spaced apart by 3 mm. The Al electrodes were directly pasted onto the PET substrate with an aluminum conductive adhesive tape (available from RS Components, Ltd.). To allow the fiber mats to contact the electrodes directly, double-sided adhesive tape (3L×0.8W mm²) was fixed adjacent to each electrode. Silver conductive paint with Al foil was used to cover the fiber mats directly.

### Example 6

### Room Temperature Gas Sensing Properties of SnO₂-MWCNT Composite Nanofibers

Sensitivity (S) is defined as S=Rₐ/R_{g}, where Rₐ is the electrical resistance of the fiber mats in atmospheric air (˜22% relative humidity), and R_{g} is the resistance of the fiber mats in a CO-air mixture at the indicated concentration and temperature.

The sensitivity of gas sensors was evaluated by measuring the sensor resistance variation under an applied DC voltage of 3V. A gas sensor of Example 5 was placed in a gas chamber having an inlet and an outlet. Air mixed with a given concentration of CO gas was flowed at 3000 ml/min through the gas chamber at 23.5° C. and ambient pressure. The electrical measurements were made using a Solartron 1287 Electrochemical Interface along with Solartron 1252A frequency response analyzer, which were connected to the sensor in the gas chamber. The concentration of CO was continuously measured by a chemiluminescence CO analyzer. After the inlet and outlet concentration achieved equilibrium (1 hr), the electrochemical interface was turned on and recorded the data.

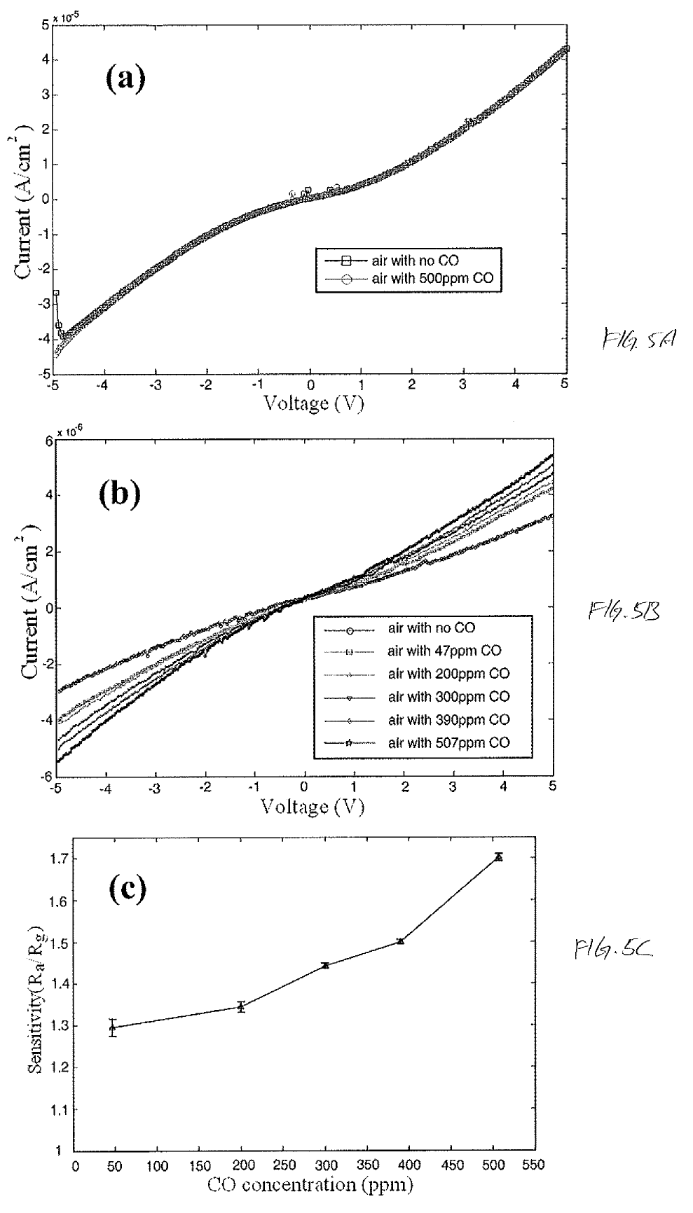

FIG. 5A displays current-voltage (I-V) curves obtained under air and under air containing 507 ppm CO. The resistance was held constant. The doped MWCNT fibers sensors were sensitive to the exposed gases, as illustrated by the variation in I-V curves in FIG. 5B. The sensor resistance decreased upon the introduction of CO gas.

FIG. 5C is a graph of the sensitivity versus various concentrations of CO gas. The mean sensitivity was 1.29 for 50 ppm of CO at 23.5° C. A linear equation S=0.0011c (concentration, ppm)+1.1207 with a correlation coefficient of 0.9502 was obtained over the range of 200-507 ppm. Moreover, gas sensors made from the calcinated SnO₂-MWCNT nanofibers showed a sensitivity to CO gas at room temperature at a low bias voltage of 3V in steady state, which indicated that the SnO₂-MWCNT nanofibers may be used in miniaturized gas sensors operating at room temperature.

While the examples of the gas sensor have been described, it should be understood that the gas sensor are not so limited and modifications may be made. The scope of the gas sensor is defined by the appended claims, and all devices that come within the meaning of the claims, either literally or by equivalence, are intended to be embraced therein.

We claim:

1. A gas sensor, comprising:
a mat comprising nanofibers attached to a substrate layer;
a first electrode in electrical communication with one end of said mat; and
a second electrode in electrical communication with the other end of said mat,
wherein the sensitivity of said gas sensor for carbon monoxide at a concentration of 50 ppm in air, and at a temperature from about 20° C. to 26° C., is at least 1.29.

2. The gas sensor of claim 1, wherein said mat comprises semiconductor metallic oxide nanofibers and multi-walled carbon nanotubes.

3. The gas sensor of claim 2, wherein said semiconductor metallic oxide is selected from the group consisting of tin oxide, gallium oxide, indium oxide, and mixtures thereof.

4. The gas sensor of claim 3, wherein said semiconductor metallic oxide comprises tin oxide.

5. The gas sensor of claim 2, wherein said multi-walled carbon nanotubes are selected from the group consisting of tin oxide/carbon nanotubes, gallium oxide/carbon nanotubes, indium oxide/carbon nanotubes, and mixtures thereof.

6. The gas sensor of claim 5, wherein said multi-walled carbon nanotubes comprise tin oxide/carbon nanotubes.

7. The gas sensor of claim 1, wherein said substrate layer is selected from the group consisting of polyethylene terephthalate (PET), polymethyl methacrylate (PMMA), Polyvinyl chloride (PVC), and mixtures thereof.

8. The gas sensor of claim 7, wherein said substrate layer comprises polyethylene terephthalate (PET).

9. The gas sensor of claim 1, wherein said first electrode comprises aluminum.

10. The gas sensor of claim 9, wherein said second electrode comprises aluminum.

11. An article of clothing, comprising a textile and the gas sensor of claim 1, integrated into the textile.

12. A method of making a gas sensor, comprising:
attaching a mat comprising nanofibers to a substrate layer;
connecting a first electrode in electrical communication with one end of said mat; and
connecting a second electrode in electrical communication with the other end of said mat,
wherein the sensitivity of said gas sensor for carbon monoxide at a concentration of 50 ppm in air, and at a temperature from about 20° C. to 26° C., is at least 1.29.

13. The method of claim 12, wherein said mat is prepared using a technique selected from the group consisting of electrospinning, thermal deposition, solution-crystal growth, laser ablation, and template-based approaches.

14. The method of claim 13, wherein said mat is prepared using electrospinning.

15. The method of claim 14, wherein said electrospinning comprises dispersing multi-walled carbon nanotubes into tin oxide precursor solutions to obtain tin oxide/multi-walled carbon nanotube composite nanofibers.

16. The method of claim 15, wherein said precursor solution comprises dimethyldineodecanoate tin, poly(ethylene oxide)/water, and chloroform.

17. A gas sensor, comprising:
a mat comprising nanofibers attached to a substrate layer;
a first electrode in electrical communication with one end of said mat; and
a second electrode in electrical communication with the other end of said mat,
wherein the nanofibers comprise semiconductor metallic oxide nanofibers and multi-walled carbon nanotubes.
